(19) United States
(12) Patent Application Publication
(10) Pub. No.: US 2025/0337515 A1
(43) Pub. Date: Oct. 30, 2025

(54) SYSTEMS AND METHODS FOR PROVIDING COMMUNICATION BETWEEN AN ACCESS POINT AND A HUB OF A POINT-TO-MULTIPOINT OPTICAL NETWORK

(71) Applicant: HUAWEI TECHNOLOGIES CO., LTD., Shenzhen (CN)

(72) Inventors: Mohammed Yousry Shaban Abbas SOWAILEM, Gatineau (CA); Ahmed Mohamed MEDRA, Kanata (CA); Chuandong LI, Ottawa (CA)

(21) Appl. No.: 18/650,954

(22) Filed: Apr. 30, 2024

(51) Int. Cl. H04J 14/02; H04Q 11/00

(52) U.S. Cl. CPC H04J 14/0238; H04Q 11/0067

(57) ABSTRACT

Systems and methods for providing communication between an access point and a HUB of a point-to-multipoint optical network are disclosed. The method includes causing the access point to determine a communication wavelength of the HUB, causing the access point to determine, using information on a control channel centered at the communication wavelength, whether the HUB has an amount of available resources allocable within a plurality of data sub-carries to the access point and, in response to identifying the available resources, establishing a bidirectional communication between the access point and the HUB.

### CROSS-REFERENCE TO RELATED APPLICATIONS

This is the first application filed for the instantly disclosed technology.

### TECHNICAL FIELD

The present disclosure generally relates to the field of communication protocols in communication networks and, in particular, to systems and methods for providing communication between an access point and a HUB of a point-to-multipoint optical network.

### BACKGROUND

In a point-to-point (PTP) optical communication system, two optical transceivers are connected to each other through a light-path established uniquely for this connection. PTP optical communication is the most widely deployed configuration, though it may not be the most efficient configuration in terms of data rate or network management in different network scenarios. For example, in long haul optical fiber transmission applications, PTP communication is well established and can be easily managed using existing technologies as optical service channels.

On the other hand, in metro region applications, it may be desirable that Point-to-Multi-Point (PTMP) optical communications links are established in which one optical transceiver, known as primary node or “HUB”, communicates with multiple transceivers, known as secondary nodes, or “Access Points” (APs).

For example, in a Passive Optical Network (PON), passive optical transmission, along with Intensity Modulation and Direct Detection (IM/DD), can be used to provide high speed data transmission form one node to another. A PON may also be a PTMP network in which one node can communicate with multiple secondary nodes in a multiple access fashion. The process of adding a new secondary node to the network through registration and ranging is defined in the existing PON standards. However, conventional PON is based on a non-coherent technology that may not require to equalize or monitor all optical channel impairments such as chromatic dispersion (CD). In coherent PTMP, the secondary node may be required to feedback many system parameters to the primary node as CD, optical signal-to-noise-ratio, received power level and residual transmitter in-phase quadrature skew (IQ skew) for proper operation or to improve the communication performance. In a PON, the control information is part of the downlink or uplink data stream which significantly limits the amount of information that can be used for control information or feedback information. In coherent PTMP, there are several configurations depending on the primary and secondary transceivers design as well as network requirements, thus providing more efficient implementation of the control and feedback channel.

Consequently, there is a need for solutions that mitigate at least some of the aforementioned drawbacks of the prior art's technologies.

### SUMMARY

Broadly speaking, the present technology aims at providing communication protocol between an access point and a HUB of a point-to-multipoint (PTMP) optical network. As will be described in greater detail herein after, an aspect of the present technology is to provide a control and feedback channel design for coherent PTMP networks. The technology addresses two main issues in the existing literature. The first issue is how to design the control and feedback channel given the network requirement and the design of the primary and secondary nodes to maximize the spectral efficiency and provides the optimal performance. The second issue is to overcome the limitations in the previous prior arts. That said, the present technology addresses the authentication and registration process for both Frequency Division Multiplexing (FDM) and Time Division Multiplexing (TDM) or combined systems as well as the ranging process for TDM signaling.

In a first broad aspect of the method, there is provided a method for providing communication between an access point and a HUB of a point-to-multipoint optical network. The method comprises causing the access point to determine a communication wavelength of the HUB. The method comprises causing the access point to determine, using information on a control channel centered at the communication wavelength, whether the HUB has an amount of available resources allocable within a plurality of data sub-carriers to the access point. The method comprises in response to determining that the HUB has the amount of available resources allocable within the plurality of data sub-carriers to the access point, point and the HUB, establishing a bidirectional communication between the access point and the HUB.

In some embodiments of the method, the amount of available resources is determined based on characteristics of the access point.

In some embodiments of the method, the causing the access point to determine the communication wavelength of the HUB comprises: tuning a central frequency of a local oscillator laser of the access point to a pre-determined wavelength; and in response to the communication wavelength of the HUB matching the pre-determined wavelength, locking a frequency and a time of sampling of the access point to the HUB.

In some embodiments of the method, the causing the access point to determine the communication wavelength of the HUB comprises: scanning by the access point pre-determined wavelengths for locking to the HUB.

In some embodiments of the method, the method further comprises, subsequent to the causing the access point to determine the communication wavelength of the HUB: transmitting, by the HUB to the access point, a sequence comprising an indicator indicative of whether the HUB has resources to offer to the access point.

In some embodiments of the method, the amount of available resource are physical resources comprising bandwidth and data sub-carriers of the HUB.

In some embodiments of the method, the causing the access point to determining that the HUB has the amount of available resources allocable within the plurality of data sub-carriers to the access point comprises: receiving, by the HUB from the access point, a request comprising information indicative of the amount of available resources for a potential establishment of a bidirectional communication between the access point and the HUB; and transmitting, by the HUB to the access point, information about a presence or an absence of the amount of available resources.

In some embodiments of the method, the causing the access point to determining that the HUB has the amount of available resources allocable within the plurality of data sub-carriers to the access point comprises: receiving, from the HUB, a training sequence, pilots and control symbols; performing clock and frequency synchronization with the HUB; extracting System Initialization Control Channel (SICCH) MAC information from the control symbols; generating a list of available resources on the HUB; monitoring a Broadcast Field in SICCH Frame to determine whether an uplink communication line is available from the access point to the HUB; upon determining that the uplink communication line is available, sending a connection request to the HUB, the connection request comprising information indicative of an amount of required resources; and in response to the amount of required resources being available at the HUB, receiving a confirmation message therefrom.

In some embodiments of the method, the method further comprises re-sending the connection request a plurality of successive times.

In some embodiments of the method, the method further comprises waiting a pre-determined amount of time after sending the connection request, and, in response to no confirmation message being received once the pre-determined amount of time has elapsed, sending a second connection request to the hub, the second connection request comprising information about a pre-determined amount of second resources.

In some embodiments of the method, the method further comprises: in response to a bandwidth of the access point being equal or wider than a wavelength spectrum including the data sub-carriers of the HUB: assigning one or more of the data sub-carriers to the access point; and transmitting data between the HUB and the access point on the assigned data sub-carriers.

In some embodiments of the method, comprising: transmitting, by the HUB to the access point, a monitoring request indicative of parameters of the access point to be monitored; causing the access point to transmit a state of the parameters to the HUB a pre-determined number of times; updating, by the HUB, information indicative of a state of the access point based on the received state of the parameters.

In some embodiments of the method, the transmitting the state of the parameters is performed using a Feedback Control Channel (FBCH).

In some embodiments of the method, the method further comprises: in response to a bandwidth of the access point being narrower than a wavelength spectrum of the data sub-carries of the HUB: causing the access point to tune a central frequency of a local oscillator laser to match a given data sub-carriers of the HUB; and defining the control channel independent from a data channel configured for carrying data between the HUB and the access point.

In some embodiments of the method, the method further comprises: transmitting, by the HUB to the access point, a monitoring request indicative of parameters of the access point to be monitored; causing the access point to transmit a state of the parameters to the HUB a pre-determined number of times; updating, by the HUB, information indicative of a state of the access point based on the received state of the parameters.

In a second broad aspect of the present technology, there is provided a system for providing communication between an access point and a HUB of a point-to-multipoint optical network. The system is configured to: cause the access point to determine a communication wavelength of the HUB; cause the access point to determine, using information on a control channel centered at the communication wavelength, whether the HUB has an amount of available resources allocable within a plurality of data sub-carriers to the access point; and in response to determining that the HUB has the amount of available resources allocable within the plurality of data sub-carriers to the access point, establish a bidirectional communication between the access point and the HUB.

In some embodiments of the system, the amount of available resources is determined based on characteristics of the access point.

In some embodiments of the system, to cause the access point to determine the communication wavelength of the HUB comprises the system configured to: tune a central frequency of a local oscillator laser of the access point to a pre-determined wavelength; and in response to the communication wavelength of the HUB matching the pre-determined wavelength, lock a frequency and a time of sampling of the access point to the HUB.

In some embodiments of the system, the causing the access point to determine the communication wavelength of the HUB comprises: scanning by the access point pre-determined wavelengths for locking to the HUB.

In some embodiments of the system, the system is configured to, subsequent to the causing the access point to determine the communication wavelength of the HUB: transmit, by the HUB to the access point, a sequence comprising an indicator indicative of whether the HUB has resources to offer to the access point.

In some embodiments of the system, the amount of available resources are physical resources comprising bandwidth and data sub-carriers of the HUB.

In some embodiments of the system, to cause the access point to determine that the HUB has the amount of available resources allocable within the plurality of data sub-carriers to the access point comprises: receiving, by the HUB from the access point, a request comprising information indicative of the amount of available resources for a potential establishment of a bidirectional communication between the access point and the HUB; and transmitting, by the HUB to the access point, information about a presence or an absence of the amount of available resources.

In some embodiments of the system, to cause the access point to determine that the HUB has the amount of available resources allocable within the plurality of data sub-carriers to the access point comprises the system being configured to: receive, from the HUB, a training sequence, pilots and control symbols; perform clock and frequency synchronization with the HUB; extract System Initialization Control Channel (SICCH) MAC information from the control symbols; generate a list of available resources on the HUB; monitor a Broadcast Field in SICCH Frame to determine whether an uplink communication line is available from the access point to the HUB; upon determining that the uplink communication line is available, send a connection request to the HUB, the connection request comprising information indicative of an amount of required resources; and in response to the amount of required resources being available at the HUB, receive a confirmation message therefrom.

In some embodiments of the system, the system is further configured to re-send the connection request a plurality of successive times.

In some embodiments of the system, the system is further configured to wait a pre-determined amount of time after sending the connection request, and, in response to no confirmation message being received once the pre-determined amount of time has elapsed, send a second connection request to the hub, the second connection request comprising information about a pre-determined amount of second resources.

In some embodiments of the system, the system is further configured to: in response to a bandwidth of the access point being equal or wider than a wavelength spectrum including the data sub-carriers of the HUB: assign one of the data sub-carriers to the access point; and transmit data between the HUB and the access point on the assigned data sub-carriers.

In some embodiments of the system, the system is further configured to: transmit, by the HUB to the access point, a monitoring request indicative of parameters of the access point to be monitored; cause the access point to transmit a state of the parameters to the HUB a pre-determined number of times; update, by the HUB, information indicative of a state of the access point based on the received state of the parameters.

In some embodiments of the system, to transmit the state of the parameters the system is configured to use a Feedback Control Channel (FBCH).

In some embodiments of the system, the system is configured to: in response to a bandwidth of the access point being narrower than a wavelength spectrum of the data sub-carries of the HUB: cause the access point to tune a central frequency of a local oscillator laser to match a given data sub-carriers of the HUB; and define the control channel independent from a data channel configured for carrying data between the HUB and the access point.

In some embodiments of the system, the system is configured to: transmit, by the HUB to the access point, a monitoring request indicative of parameters of the access point to be monitored; cause the access point to transmit a state of the parameters to the HUB a pre-determined number of times; update, by the HUB, information indicative of a state of the access point based on the received state of the parameters.

### BRIEF DESCRIPTION OF THE FIGURES

The features and advantages of the present disclosure will become apparent from the following detailed description, taken in combination with the appended drawings, in which:

FIG. 1 is a block diagram of a Point-to-Multipoint (PTMP) network architecture in accordance with some implementations of the present technology;

FIG. 2 is an illustration of signals generated by the HUB and including a plurality of sub-carriers in accordance with some implementations of the present technology;

FIG. 3 is a flow diagram of a protocol for providing communication between a given access point and a HUB of the PTMP network of FIG. 1 in accordance with some non-limiting implementations of the present technology;

FIG. 4 illustrates an authentication process 400 in accordance with some non-limiting implementations of the present technology;

FIG. 5 is an illustration of Physical and Logical aspects for the Control Channel in case of a high-performing access point in accordance with some non-limiting implementations of the present technology;

FIG. 6 is an illustration of Physical and Logical Control Channel for a low-performing access point in accordance with some non-limiting implementations of the present technology;

FIG. 7 is an illustration of Physical and Logical Control Channel for a low-performing access point in accordance with some other non-limiting implementations of the present technology;

FIG. 8 is an illustration of Physical and Logical Control Channel for a high-performing access point in accordance with some other non-limiting implementations of the present technology;

FIG. 9 is a flow diagram showing operations of a method for providing communication between an access point and a HUB of a point-to-multipoint optical network in accordance with some non-limiting implementations of the present technology;

FIG. 10 is a block diagram of a system according to some non-limiting implementations of the present technology;

FIG. 11 is a schematic representation of a preamble list according to some non-limiting implementations of the present technology;

FIG. 12 is an illustration of a spectrum arrangement in accordance with some non-limiting implementations of the present technology;

FIG. 13 illustrates a physical Downlink broadcast Channel Frame structure in accordance with some non-limiting implementations of the present technology;

FIG. 14 illustrates an Uplink Shared Channel Frame structure in accordance with some non-limiting implementations of the present technology;

FIG. 15 illustrates a frame structure of the Downlink broadcast channel frame of an access point in accordance with some non-limiting implementations of the present technology;

FIG. 16 illustrates an uplink shared channel frame structure in accordance with some non-limiting implementations of the present technology;

FIG. 17 is a flow diagram of a Monitoring procedure in accordance with some non-limiting implementations of the present technology; and

FIG. 18 illustrates a modified data channel frame structure in accordance with some non-limiting implementations of the present technology.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

Various representative embodiments of the disclosed technology will be described more fully hereinafter with reference to the accompanying drawings, in which representative embodiments are shown. The presently disclosed technology may, however, be embodied in many different forms and should not be construed as limited to the representative embodiments set forth herein. Rather, these representative embodiments are provided so that the disclosure will be thorough and complete, and will fully convey the scope of the present technology to those skilled in the art. In the drawings, the sizes and relative sizes of layers and regions may be exaggerated for clarity. Like numerals refer to like elements throughout. And, unless otherwise defined, all technical and scientific terms used herein have the same meaning as commonly understood by one of ordinary skill in the art to which the described embodiments pertain.

Generally speaking, a point-to-multipoint (PTMP) network is a communication topology that connects a main transceiver to multiple transceivers. In this network architecture, the main transceiver can communicate with several peripheral transceivers simultaneously. The main transceiver may be referred to as a “central point”, a “point of origin”, the “primary point” or a “HUB” of the PTMP network. The multiple transceivers may be referred to as “secondary points”, “leaf nodes” or “access points” (AP). P2MP networks are commonly used in various applications, such as, for example and without limitation, broadcasting, video conferencing, satellite communication, wireless networks, and telecommunications.

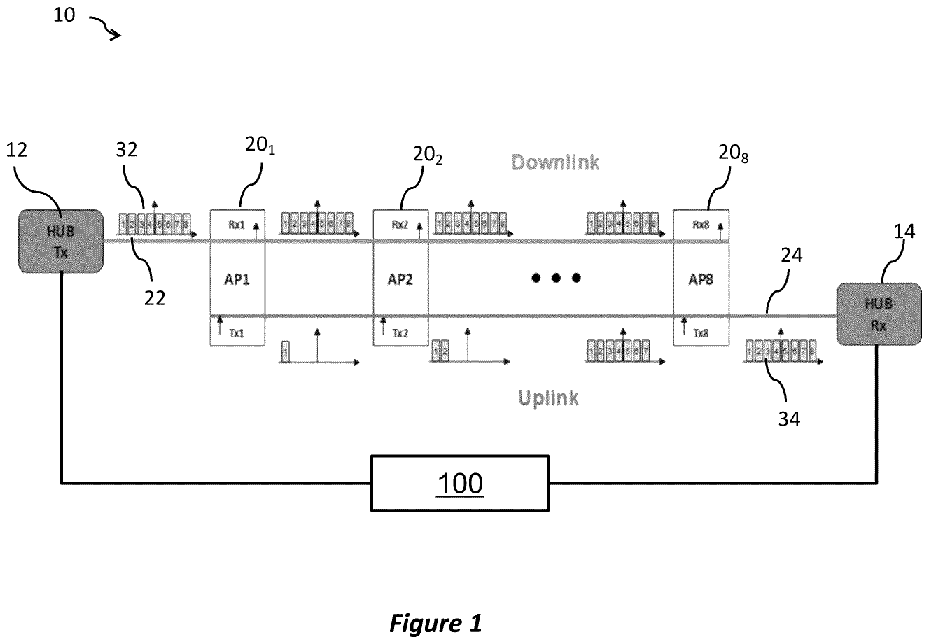

FIG. 1 is a block diagram of a PTMP network architecture 10 in accordance with some implementations of the present technology. In this example, a HUB of the PTMP network includes a HUB transmitter component 12 and a HUB receiver component 14 communicable connected to a computing unit 100. In use, the HUB may thus transmit data from the HUB transmitter component 12 to a plurality of access points (AP) 20₁-20₈, and receive data therefrom at the HUB receiver component 14. In this example, the HUB is connected to eight APs. Therefore, a signal 32 generated from the HUB carries 8 sub-carriers, in which each sub-carrier i is dedicated to one APᵢ. For example, AP 20₁ may be assigned sub-carrier 1, AP 20₂ may be assigned sub-carrier 2 and so on. In some implementations, the HUB and APs are physically connected using a pair of fibers, a first fiber 22 for downlink (DL) communications (i.e. from the HUB transmitter component 12 to the AP i) and second fiber 24 for uplink (UL) communications (i.e. from the AP i to the HUB receiver component 14). In some implementations, only one fiber can be used for bidirectional communications.

It should be noted that the HUB transmitter component 12 and the HUB receiver component 14 may be located and implemented in a same device. It is contemplated that the HUB transmitted component 12 and the HUB receiver components 14 may be on a same site or physical location, without departing from the scope of the present technology.

To ease an understanding of the present disclosure, the present technology will be explained assuming dual fiber configuration (i.e. using the fiber 22 for downlink communications and the fiber 24 for uplink communications). Broadly speaking, each AP 20 tries to synchronize to the HUB by decoding the received signal from the HUB during the downlink transmission. The synchronization process aims to lock the AP's clock to the HUB's clock and the AP's laser oscillator frequency to the HUB's laser oscillator frequency. Therefore, time and frequency synchronizations are performed. Scanning of the wavelengths by the AP 20 will be described in greater detail herein after.

Once the AP is locked to the HUB during downlink transmission, the AP 20 may start sending a corresponding signal to the HUB in the uplink direction. The uplink direction is established using a dedicated fiber, different from the downlink fiber. However, it is also possible to use one fiber for both uplink and downlink direction by using bidirectional transmission or by assigning different sub-carriers to each direction. In some implementations, several APs 20 may use the same sub-carrier in the PTMP by using TDM signalling.

For downlink communications, the HUB transmits the signal 32 for all APs 20 assigned to a given sub-carrier. While each AP 20 can equalize the entire signal, it extracts only the information related to itself and neglects other information dedicated to other APs. However, in the uplink, each AP 20 sends its signal separately.

In some embodiments, in the case of FDM signaling, the HUB can receive each sub-carrier independently and interference may be avoided or at least reduced by having appropriate guard bands in-between with specific requirements. In other embodiments, in the case of TDM signaling, the received signals at the HUB from different APs, illustrated as the signal 34 on FIG. 1, can collide and interfere with each other unless they are sent on specific time stamps after performing “ranging”. During the authentication process, the HUB may send timing adjustment through the control channel to assure these time stamps are handled accurately. Therefore, in some embodiments, each AP may have a dedicated time slot to transmit its data to the HUB during which all other APs are silent—that is, the other APs do not send data to the HUB receiver component 14.

In further embodiments, the architecture 10 may be configured to allow TDM signaling over a given sub-carrier by adding independent control and feedback channel(s) to the signal synthesized from the nodes' transmitters (e.g., “Physical Channel” modification) and adjusting the MAC layer. This layer has Logical Control channels that have information fields to be read and/or written in the physical control and feedback channel to support the desired requirements. It is contemplated that the desired requirements include, but are not limited to: authentication, registration, ranging, configuration, re-configuration, monitoring, feed-backing, reading status and controlling all nodes in the network, for example.

It should be noted that use of a control channel is needed for both FDM and TDM, however, TDM may require comparatively more control (e.g., ranging technique). It is further contemplated that in some embodiments, both TDM and FDM may be used, where respective sub-carriers are divided into time slots, and without departing from the scope of the present technology.

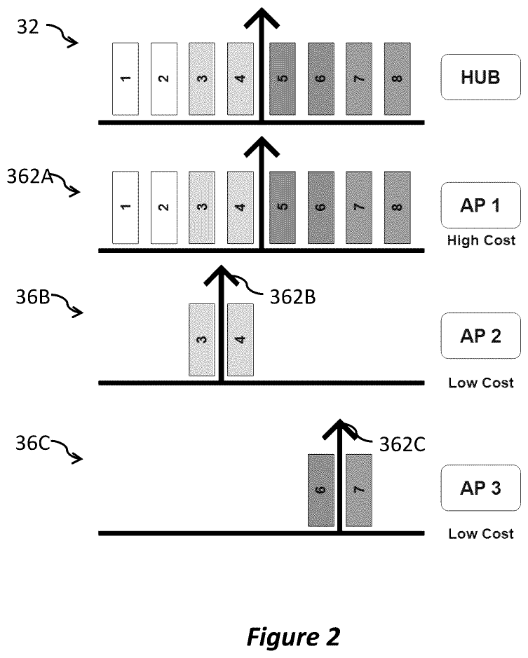

It should thus be noted that performances of the downlink communications depend on a number of APs 20 and performances thereof. FIG. 2 illustrates the signal 32 generated by the HUB and including a plurality of sub-carriers, each sub-carrier corresponding to one of the AP in the PTMP network 10. In the context of the present disclosure, a given AP is considered high-performing when the given AP is able to access an entire spectrum generated from the HUB. Also in the context of the present disclosure, a given AP is considered low-performing when the given AP is only able to access a portion of the entire spectrum.

Therefore, for a high-performing AP, the AP laser's center frequency may be adjusted to the center of the spectrum and it can be assigned any sub-carrier instantaneously. While this design provides great flexibility, it is also expensive due to components bandwidth requirements. For example, a signal 36A sampled at the AP 20₁ in FIG. 2 includes all the sub-carriers of the signal 32, the AP 20₁ should thus have the same sampling rate for digital-to-analog-converter (DAC) and analog-to-digital-converter (ADC) as the HUB. It can thus be said that the AP 20₁ is a HUB transceiver, but configured as an access point.

A low-performing AP can only access few sub-carriers by adjusting its laser center frequency. For example, a signal 36B detected at the AP 20₂ shows that the AP 20₂ is only able to detect the sub-carriers 3 and 4 around its laser center frequency 362B. This reduces the bandwidth requirements and hence the price of the components of AP 20₂. In FIG. 2, AP 20₂ and AP 203 are both low-performing APs, each is centered tuned to a different pair of sub-carriers, the AP 203 having its laser center frequency 362C different than the laser center frequency 362B such that the AP 203 can detect sub-carriers 6 and 7. In this example, AP 20₂ and AP 203 can only access one-fourth of the spectrum generated by the HUB.

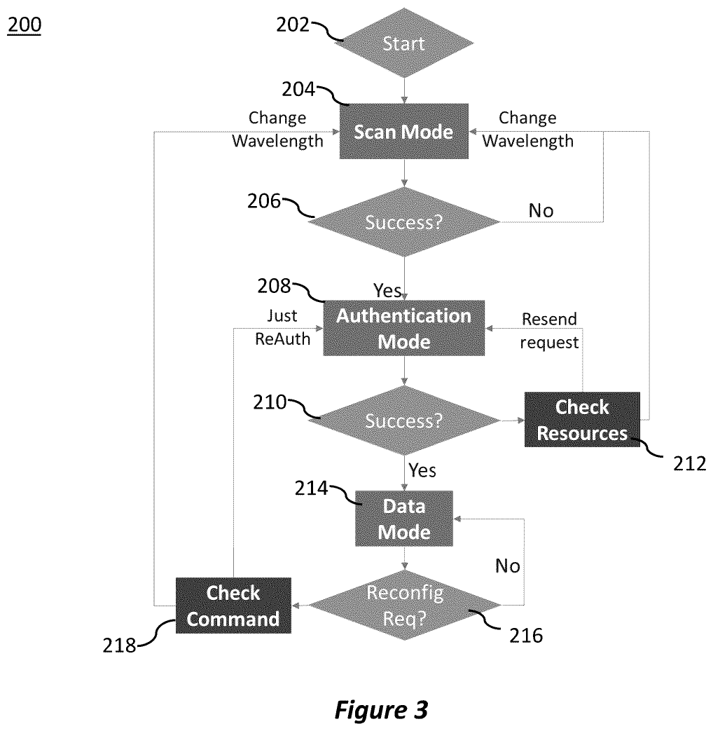

FIG. 3 is a flow diagram of a protocol 200 for providing communication between a given access point 20; and the HUB of the point-to-multipoint optical network 10 in accordance with some non-limiting implementations of the present technology. Some steps of the protocol 200 are called “modes” namely; the scan mode, the authentication mode and the data mode.

### Scan Mode

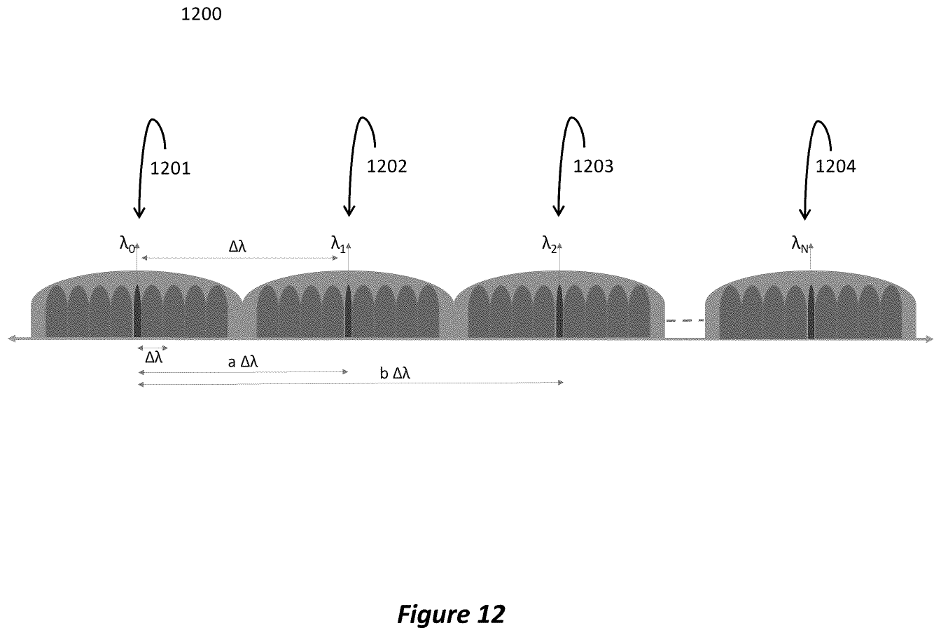

Broadly speaking, in the scan mode at operation 204, the AP scans the spectrum grid to find the appropriate HUB/wavelength to connect to the desired network. More specifically and with reference to FIG. 12, there is depicted a spectrum arrangement 1200 in accordance with some non-limiting implementations of the present technology. When the AP is added to the PTMP network 10, the AP tunes its laser's center frequency to a given λ₀ 1201 within its accessible range. If the HUB transmits data at this wavelength, the AP will use the DL broadcast channel to lock its frequency and time to the primary node. The DL broadcast channel is a single polarization channel where the X-polarization and Y-polarization will have the same information simultaneously. If no signal is detected, the AP incrementally adjusts its laser center frequency to search for a wavelength that is used by the HUB for transmission. This may be referred to as the acquisition process in which the AP locks its clock and frequency to the HUB.

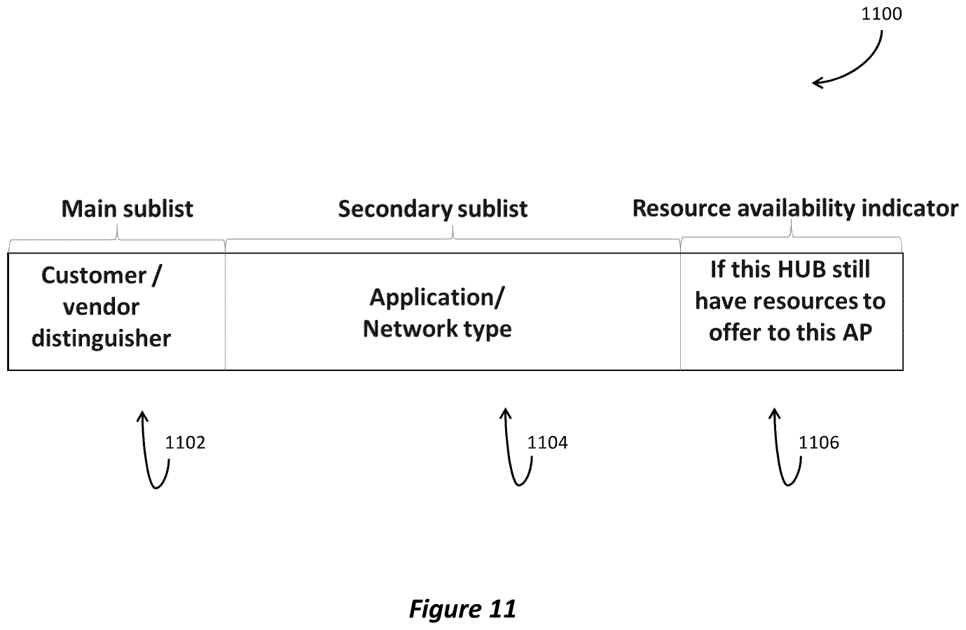

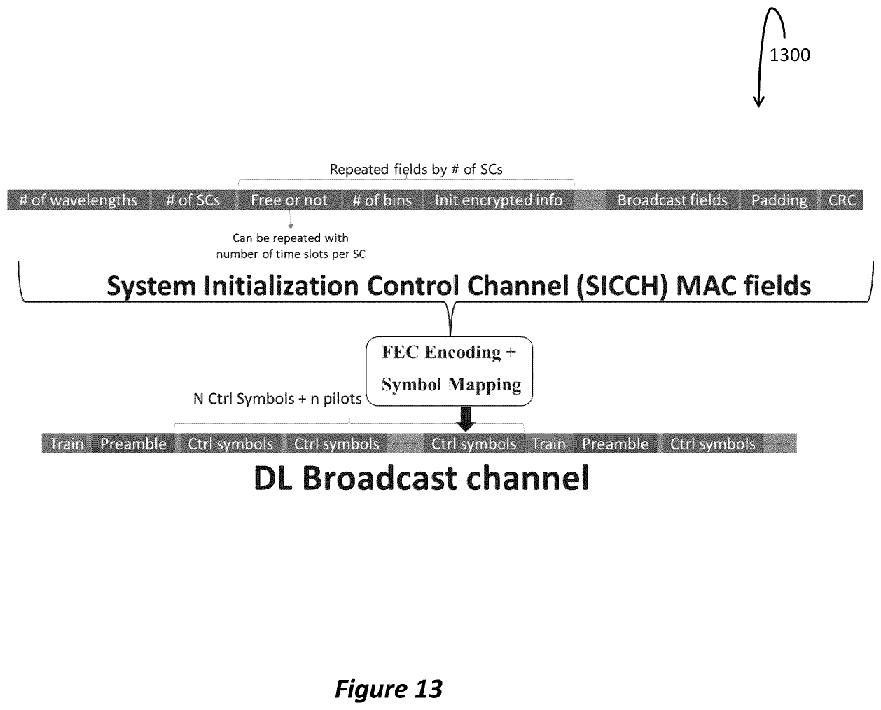

In some embodiments, and with reference to FIG. 13, which depicts a physical layer frame structure 1300, the DL broadcast channel includes the following information:
Training sequence and pilots which are common for all HUBs that may belong to the PTMP network 10;
Special preamble for each HUB that indicates a network owner, an example of a preamble list 1100 being depicted on FIG. 11. In some implementations, the preamble list is divided into three portions: a main sub-list 1102 that is used as the customer/vendor distinguisher, a secondary sub-list 1104 that defines the application/network/service type provided, and a last portion is a primary indicator 1106 if this specific wavelength has resources to offer to the AP;
Control symbols that represent the MAC information (e.g. using BPSK or QPSK modulation format with repetition and relatively high FEC overhead)

An illustrative implementation of the physical DL broadcast Channel Frame structure along with System Initialization Control Channel (SICCH) MAC fields are shown on FIG. 13. These fields may be described as follows:

| Field | | |
|---|---|---|
| Number | Field | Function |
| 1 | # of wavelengths | Number of wavelengths that this HUB generates, assuming that each HUB may |
| | | have multiple transceivers. |
| | | HUB can be owned by the vendor and allocate transceivers to operators forming |
| | | a virtual HUB or for high scale operators they can have their own HUB and get |
| | | transceivers from different vendors |
| 2 | # of SCs | Total number of sub-carriers for this wavelength. |
| 3 | Free or not | Free indicator which indicates if this sub-carrier is free to be allocated for new |
| | | connection or not in case of FDM only configuration |
| | | In case of TDM/FDM configuration, it can be repeated by the number of time |
| | | slots (TSs) |
| 4 | # of bins | BW indicator of a sub-carrier (for example, by assuming a given Frequency |
| | | Fourier Transform (FFT) size and sampling rate.) It can be agreed to be a certain |
| | | frequency resolution only Af instead of bins and the FFT size can be decided by |
| | | the vendors independently. |
| 5 | Init encrypted info | These fields are encrypted by the AP unique encryption key to which the HUB is |
| | | responding to its request. It is used for the following functions: |
| | | 1. Determine which sub-carrier/time slot is assigned to the AP. |
| | | 2. Timing adjustment (Ranging) in case of TDM |
| | | 3. System Configuration |
| 6 | Broadcast fields | It contains the following fields: |
| | | Number of broadcast fields. This allows for future fields addition. |
| | | MAC frame number field |
| | | Uplink Shared Channel free indicator to allow new or reconfigured APs to |
| | | send connection request |
| | | Number of physical frames that HUB needs to train the Uplink Shared |
| | | Channel reception. |
| | | Each broadcast field has field header including field length. |
| | | The newly added features have to be at the end such that we keep APs that |
| | | use old configurations |
| 7 | Padding | Padding to adjust the number of multiple physical frames |
| 8 | CRC | Cyclic Redundancy Check (CRC) field to add more protection |

In some implementations, the DL broadcast channel frame also includes Control symbols, which are the symbol-mapped bits of MAC System Initialization Control Channel (SICCH) fields after Forward Error Correction (FEC) encryption for channel protection. The DL Broadcast Frame Length may have to be an integer value of the downlink data channels Frame Length. While the training sequence and pilots may help the AP connect to the HUB, the preamble may be used to determine a network operator. If determination is made that the AP is not connected to the right operator, the AP may start to scan a second wavelength on the grid. The training sequence and preamble are designed to help AP perform timing and clock recovery, frequency offset estimation, CD estimation and channel estimation and equalization.

With reference to FIG. 12, there is shown an illustrative example in which all the signals have the same bandwidth and each one is located at a given optical wavelength forming a fixed grid. It can be seen that wavelengths 1201, 1202, 203 and 1204 are illustrated as being evenly spaced along a spectrum. In other words, λ₁=λ₀+Δλ, λ₂=λ₁+Δλ, . . . , λ_{N}=λ₀+NΔλ, where Δλ represents a fixed channel spacing. The HUBs may have arbitrary bandwidths per transceiver but the central frequency has to be integer multiple of certain granularity such that: λ₁=λ₀+a Δλ, λ₂=λ₁+b Δλ, . . . , λ_{N}=λ₀+k Δλ, where Δλ is a basic search unit.

In some embodiments, it can be said that in response to the communication wavelength of the HUB being different than the pre-determined wavelength, the access point may be configured to iteratively adjusting the center frequency by a pre-determined amount till it synch with the HUB communication wavelength.

With reference to FIG. 3, at operation 206, if the AP successfully performs the scan mode (i.e. successfully locks its clock and frequency to the HUB), the AP enters the authentication mode at operation 208. Otherwise, it adjusts its laser center frequency for performing additional scanning.

### Authentication Mode

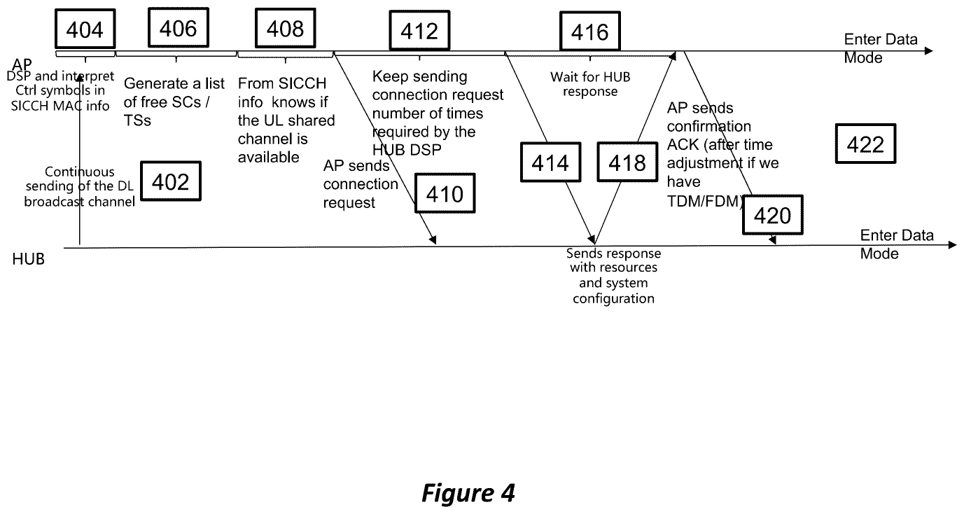

In the context of the present disclosure, the authentication mode may include “resource allocation” step. Indeed, as will be described in greater details herein after, the AP performs an authentication process with the HUB to indicate a type and/or an amount of resource of the HUB that would be required to establish suitable data communication (e.g. bidirectional) between the HUB and the AP. FIG. 4 illustrates an authentication process 400 in accordance with some non-limiting implementations of the present technology.

The authentication process 400 starts with sending, by the HUB, at operation 402, the DL broadcast control channel frames which contains the training sequence and pilots. The process 400 continues with performing, by the AP at operation 404, clock and frequency synchronization and decoding of the control symbols to extract the SICCH MAC information.

The process 400 continues with generating, by the AP at operation 406, a list of available resources on the HUB in terms of sub-carriers and time slots (in case of implementing TDM/FDM, for example). In some alternative implementations, the HUB may allocate one physical resource, i.e., a given sub-carrier and a given time slot even though the HUB has more resources available. In this case, the AP may find only one available resource to request.

The process 400 continues with monitoring, by the AP at operation 408, the “Broadcast Fields” in SICCH Frame to determine when the UL shared channel is available. In response to determination being made that the UL shared channel is available, the AP sends a connection request to the HUB at operation 410.

The process 400 continues with sending, by the AP at operation 412, multiple occurrences of the connection request. The connection request may thus be transmitted several times to the HUB. A pre-determined number of times of occurrences may be listed in the “Broadcast Fields” in the SICCH Frame. This allows the HUB to perform acquisition for the uplink channel and Authentication Control Channel (ACCH) reception. It should be noted that the ACCH Frame may include the connection request in addition to other fields as AP Encryption key, which will be used for information encryption for this AP in case of successful authentication.

At operation 414, the AP has sent a last connection request based on the pre-determined number of occurrences and enters a standby mode at operation 416 until a response is received from the HUB at operation 418. Once the response is received from the HUB at the AP, the AP may transmit an acknowledgment response to the HUB at operation 420. The AP further enters the data mode at operation 422 which ends the authentication process 400.

Broadly speaking, AP sends a connection request to the HUB seeking for resource allocation (i.e. bandwidth, wavelengths, etc.) during the authentication process 400 of the authentication mode. Referring back to FIG. 3, if the HUB successfully grants the AP the required physical resources to perform the data connection at operation 210, the AP enters the data mode at operation 214. Otherwise, if the required resources may not be allocated by the HUB to the AP at operation 212, the AP may resend the request (see operation 412 of the process 400) after a given time period based on updated information in the SICCH (if any) and as if the process is repeated again. In other words, if the HUB still has resources but the AP did not receive any resource allocation, the AP may resend another connection request. If the HUB does not have resources anymore to establish the connection with the AP, the AP may re-enter the scan mode (see operation 204 on FIG. 3).

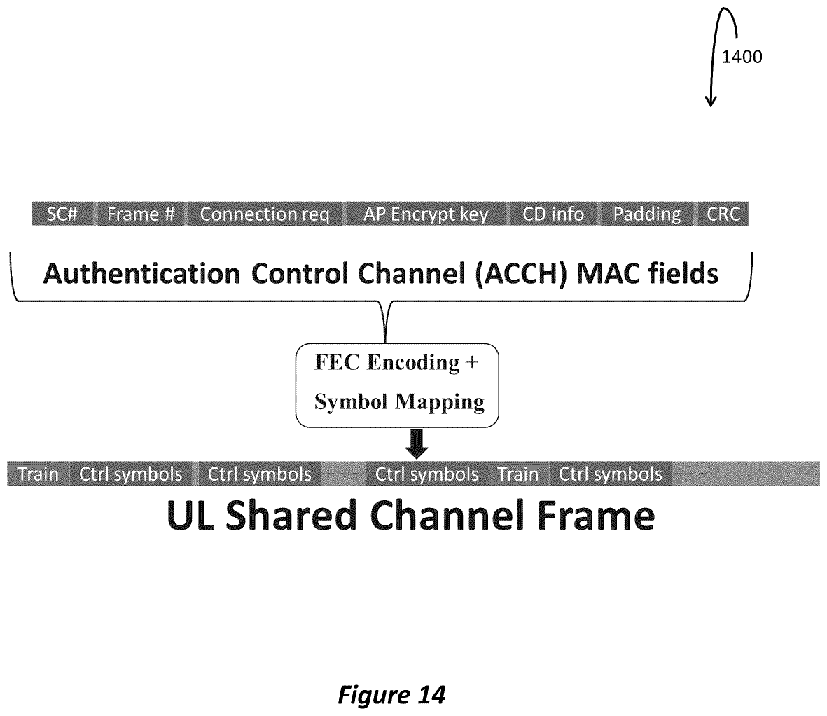

Similar to the downlink, in the uplink direction, the Uplink Shared Channel Frame is used in the authentication process by the HUB. FIG. 14 shows an illustrative implementation of the Uplink Shared Channel Frame structure 1400. It may include training sequences to allow the HUB the acquisition process followed by the control symbols. These symbols are symbol-mapped bits representing the Authentication Control Channel (ACCH) MAC fields after FEC encoding. The fields are described as follows:

| Field Number | Field | Description |
|---|---|---|
| 1 | SC# | Requested sub-carrier number for connection |
| 2 | Frame # | Frame number when: |
| | | 1. The connection request has been sent. |
| | | 2. The acknowledgment to the system configuration has been sent. |
| 3 | Connection req | Connection request |
| | | Acknowledgment to the system configuration |
| 4 | AP Encrypt key | A dedicated Encryption Key for each AP. |
| 5 | CD info | CD information (multiple of predefined resolution ΔCD) |
| 6 | Padding | Padding to adjust the number of multiple physical frames |
| 7 | CRC | Cyclic Redundancy Check (CRC) field to add more protection |

### Data Mode

Once the authentication mode has been successfully performed at operation 210, the AP 20 enters the data mode. Broadly speaking, in the data mode, the AP 20 starts receiving and sending data on the assigned physical resources while monitoring the management information from the HUB.

In the data mode, the HUB and AP MAC layer may perform management procedures such that the HUB may send commands and monitoring request and the AP 20 may send acknowledgement and feedback. In some implementations, the management logical channel used by the MAC layer on the physical resources (DL broadcast channel, UL shared channel, other dedicated/shared sub-carriers or part of data channels themselves) is mapped based on a bandwidth of the AP 20.

### High-Performing AP

If the AP 20 is a high-performing AP (i.e. has a relatively wide bandwidth to can access the entire spectrum of emission of the HUB), the AP 20 may start data reception from the HUB on the assigned sub-carrier in the DL direction and data transmission to the HUB on the assigned sub-carrier/time slot in the UP direction. It should be noted that in some implementations, in the DL direction, the AP 20 may receive all the information for other APs, but decodes only its intended data. In these implementations, each AP's data may also be encrypted by the AP Encryption Key for security and privacy. In addition to user's data information, the AP 20 may still be able to receive the DL broadcast channel, which will include management and monitoring instruction. Also, in the UL direction, the AP 20 may send acknowledge or feedback information to the HUB using UL shared channel.

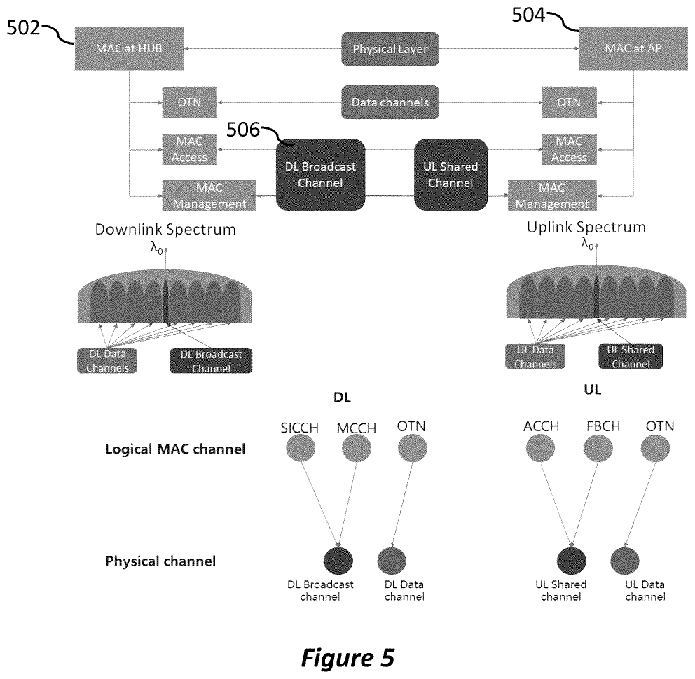

FIG. 5 shows the physical and logical aspects for the control channel in case of a high-performing AP 20. A MAC layer 502 at HUB and a MAC layer 504 at the AP 20 are connected to the physical data channels and DL broadcast and control channel. In the DL direction, an extra broadcast channel 506 had been added to the spectrum containing DL data channels. The same is also configured for the uplink direction. The bandwidth of this broadcast channel is set to be relatively narrow (e.g. ten times narrower) compared to the bandwidth of the DL data channel and the amount of information it carries is also relatively reduced. In this way, spectral efficiency loss due to broadcast channel insertion may be limited.

In use, the MAC layer 502 in the HUB sends broadcast messages to assign time-frequency resources to the AP 20. The MAC layer 504 at AP 20 reads these messages and respond accordingly using the UL shared channel. The same broadcast channel may further be used as a management and feedback channel, thus saving extra bandwidth. In this case, the DL broadcast channel frame may be modified to the frame structure shown in FIG. 12. The major change is the addition of the Management Control Channel (MCCH) MAC fields. Thus, the N control symbols in the DL broadcast channel frame are divided into two groups. The first group includes M control symbols (bit-to-symbol mapped SICCH MAC fields) for MAC access (discussed before) and the second group which includes L control symbols (bit-to-symbol mapped MCCH MAC fields) for MAC management.

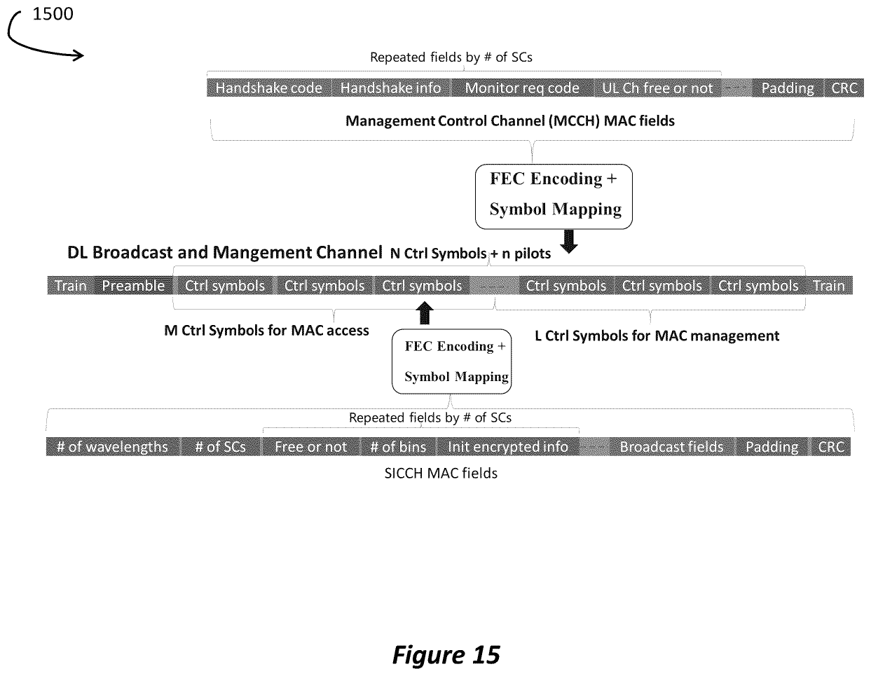

FIG. 15 shows a frame structure 1500 of the Downlink broadcast channel frame of the AP 20 according to some implementations of the present technology. In this implementation, the frame structure includes Management Control Channel (MCCH) MAC fields. Thus, the N control symbols in the DL broadcast channel frame may be divided into two groups. The first group includes M control symbols (bit-to-symbol mapped SICCH MAC fields) for MAC access (discussed before) and the second group which includes L control symbols (bit-to-symbol mapped MCCH MAC fields) for MAC management. These fields are described as follows:

| Field | | |
|---|---|---|
| Number | Field | Description |
| 1 | Handshake Code | Any process that needs handshake |
| | | System mode change |
| | | OSNR code to provide OSNR value in Handshake info |
| | | Timing adjustment change (Ranging) in case of TDM |
| | | System reconfiguration (change sub-carriers, change wavelengths) |
| | | Hitless upgrades, etc |
| 2 | Handshake Information | Handshake information to move from one stage to another or give the value of |
| | | timing readjustment |
| 3 | Monitor Request Code | Send Monitor Request to AP such as: |
| | | SNR calculation |
| | | Transmitter impairments (Transmitter IQ skew, Transmitter IQ |
| | | imbalance) interference estimation |
| | | Spectrum shape like Wavelength Selective Switch (WSS) effects or |
| | | transmitter/receiver pre-emphasis/equalizer optimization |
| | | Power gain control loop |
| 4 | UL Channel free or not | UL shared channel is free for this AP to send Acknowledgement or Monitor |
| | | information |
| 5 | Padding | Padding to adjust the number of multiple physical frames |
| 6 | CRC | Cyclic Redundancy Check (CRC) field to add more protection |

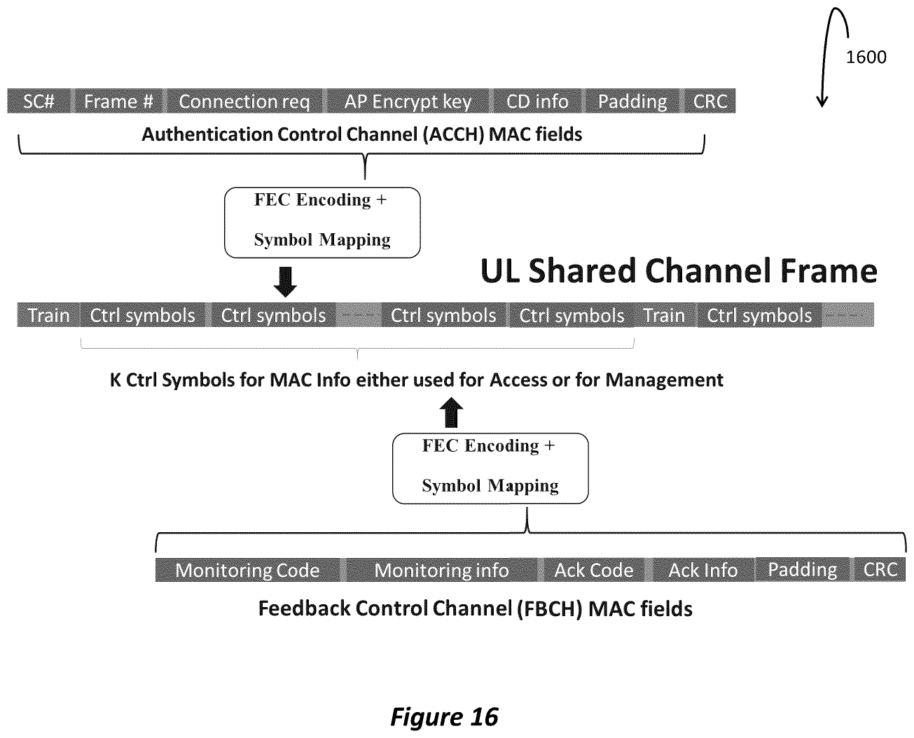

In a similar manner, in the uplink direction, the Uplink shared channel may also be used to feedback the AP's response to control and monitoring requests from the HUB. Thus, an Uplink shared channel frame structure 1600 may be represented as shown on FIG. 16. The fields may be described as:

| Field Number | Field | Description |
|---|---|---|
| 1 | Monitoring Code | The corresponding code to the request |
| 2 | Monitoring info | The required measurement or feedback |
| 3 | Acknowledge Code | The corresponding Acknowledge (ACK) code to the handshake command |
| | (ACK Code) | |
| 4 | Acknowledge | The ACK information in response to the current handshake stage. |
| | information | |
| | (ACK info) | |
| 5 | Padding | Padding to adjust the number of multiple physical frames |
| 6 | CRC | Cyclic Redundancy Check (CRC) field to add more protection |

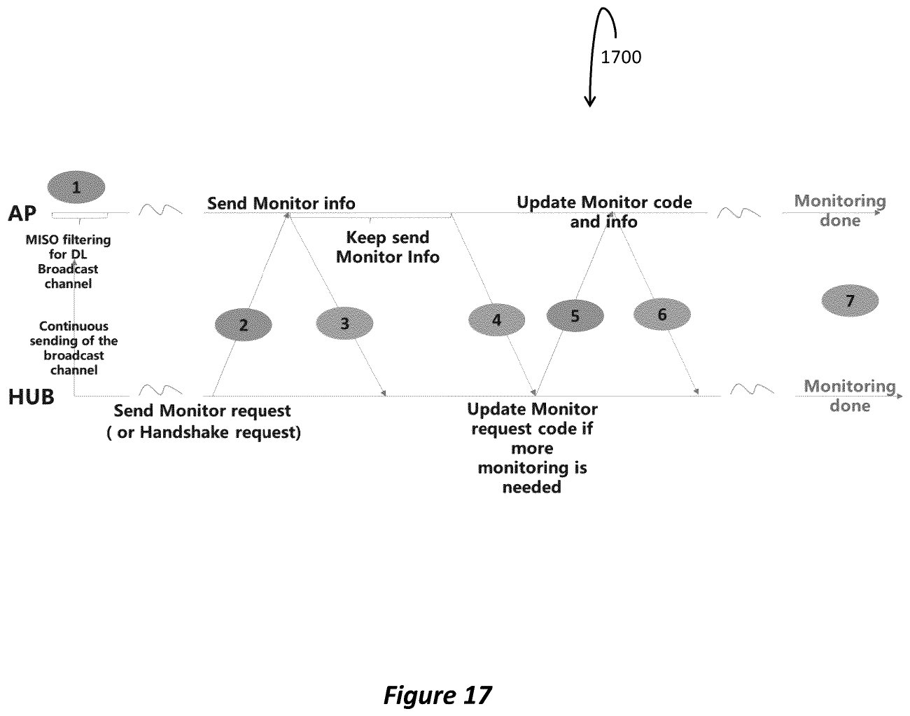

The HUB may control and monitor, or “manage” the AP. To do so, two procedures may be conducted: the Hand-Shaking procedure and the Monitoring Request procedure. In this implementation, the steps of performing any of the two procedures is the same and hence, only a flow diagram 1700 of a monitoring procedure is described with respect to FIG. 17, even though it may be applied in an identical way to the Hand-Shaking Procedure. More specifically, a given AP may keep receiving the DL broadcast and control channel sent by the HUB in the downlink direction at a first step of the procedure. At a given instant, the HUB may further send a “Monitor Request” to the AP. The AP receives the Monitor request code in MCCH MAC layer and identifies the required monitoring information needs to be fed-back to the HUB. When the resources are available for this AP (e.g., assigned sub-carrier and time/slot), the AP may further send the Monitoring information to the HUB using FBCH on the UL shared channel. The AP may further keep sending said information for a pre-determined number of repetitions. For example, the number of repeated transmissions may be determined by the HUB in the Broadcast field in SICCH. The HUB may further update its information regarding this AP and decides whether more information is still needed. If this is the case, the HUB sends a new Monitoring Request code, corresponding to the new required information using MCCH. The AP may repeat the last three steps of the procedure until no new information is requested from the HUB.

### Low-Performing AP

If the AP 20 is a low-performing AP (i.e. has a relatively narrow bandwidth and cannot access the entire spectrum of emission of the HUB), the AP may shift its laser's center frequency to be able to receive the assigned sub-carrier and/or time slot. The present technology provides three options to allocate appropriate physical resources (Management channel) for the MAC management logical channels. The first option uses a fraction of the data frame structure for management and monitoring information. The second two options rely on dedicated DL control channels and UL control channels for management and monitoring information. These channels are different from the DL broadcast channel and UL shared channel.

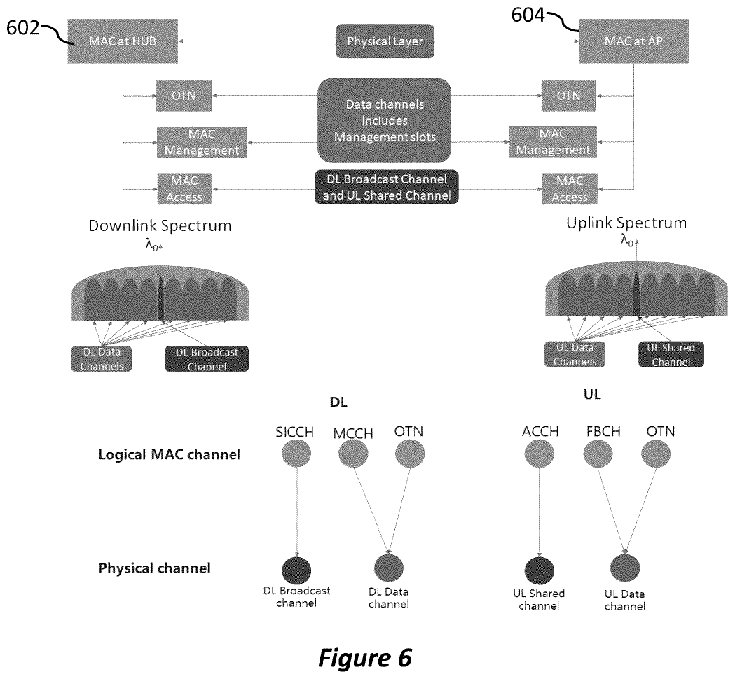

As shown on FIG. 6, the aforementioned first option for the physical and logical aspects for the control channel in case of a low-performing AP 20, the DL broadcast channel is used only for access, and the MAC layer management is done using Frame structure in OTN.

Due to the relatively narrow bandwidth of the low-performing AP, the access and control procedures may not be done using one broadcast and management channel. During the scan mode, the AP 20 may tune its laser's center frequency to the DL broadcast channel and do time and frequency synchronization to the HUB. In some implementations, the HUB periodically broadcasts free resources for APs that are requesting to join the PTMP network 10. After the AP 20 is assigned a given sub-carrier/time slot, the AP 20 may move its laser's center frequency to the assigned sub-carrier. In this case, the AP may not read the DL broadcast channel anymore. To solve this issue, the MAC layer may use a portion of the Data Frame structure to convey management and feedback information between the HUB and the AP.

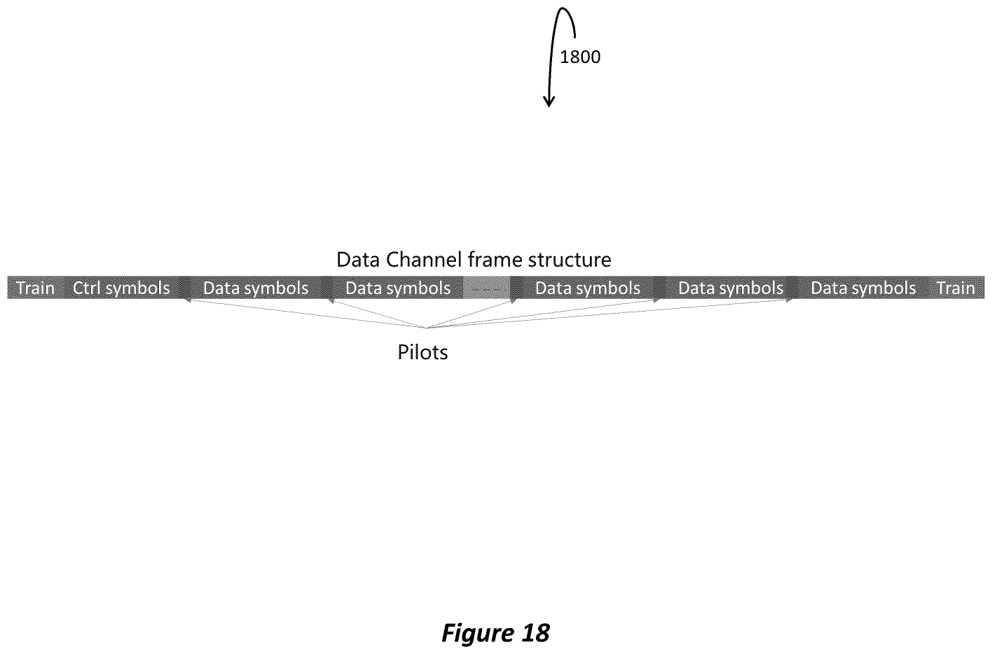

FIG. 18 shows a modified data channel frame structure 1800 in which the training sequences are followed by the control symbols, then followed by user's data. These control symbols represent the MAC layer information embedded in the data frame and not on a separate channel as discussed for an AP with large BW. The fields in these control symbols should include MCCH MAC layer information in the downlink direction and FBCH MAC layer information in the uplink direction

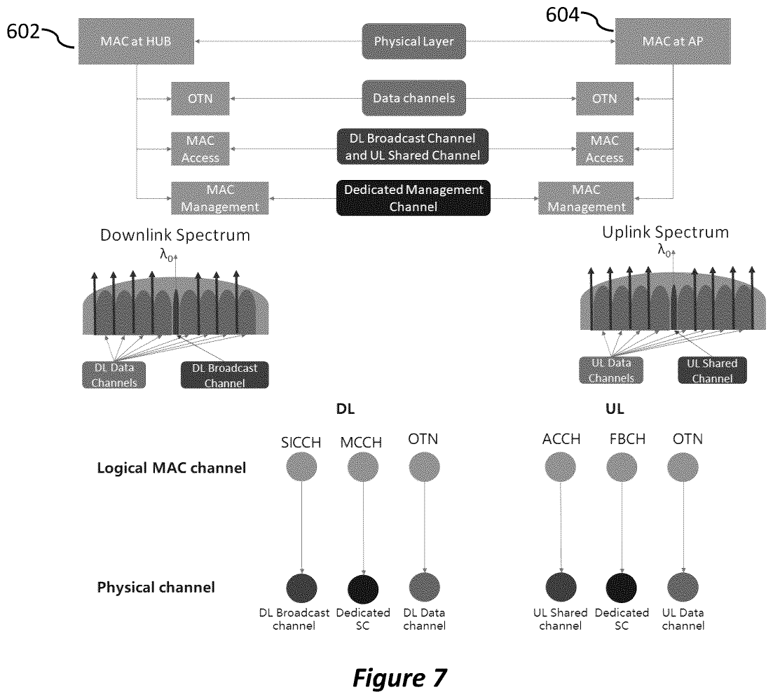

However, it may be desirable that the control channel is independent of the data channels for various reasons, such as providing operation of the control channel even if there is a failure in the data channels. Other reasons may include faster access, security and privacy issues and reduced spectral efficiency loss. FIG. 7 shows the second option for the physical and logical aspects for the control channel in case of a low-performing AP 20. In this implementation, single tone carriers are inserted beside each data sub-carrier. These single-tone carriers may be inserted in the guard band between each data sub-carrier with each single-tone carrier assigned to one data sub-carrier. These single-tone carriers may be modulated using any known modulation scheme as amplitude modulation (AM), frequency modulation (FM) or On-Off keying (OOK).

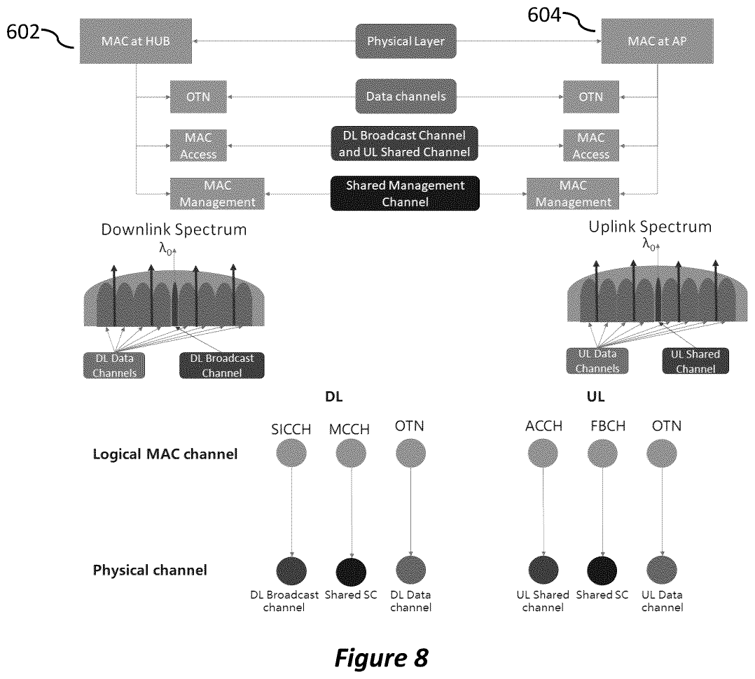

FIG. 8 illustrates the third option for the physical and logical aspects for the control channel in case of a low-performing AP 20. Instead of using a dedicated single-tone carrier for each data sub-carrier as in FIG. 7, a single tone-carrier is shared between each two data sub-carriers. This provides robustness against filtering for the single-tone carriers. Also, this may help to reduce the guard band between data sub-carriers. In this case, after authentication and registration with the HUB, the low-performing AP may move its laser's center frequency to the assigned data sub-carrier, with access to a dedicated control and management channel. The implementation of FIG. 8 provides a shared control and management channel for every pair of sub-carriers.

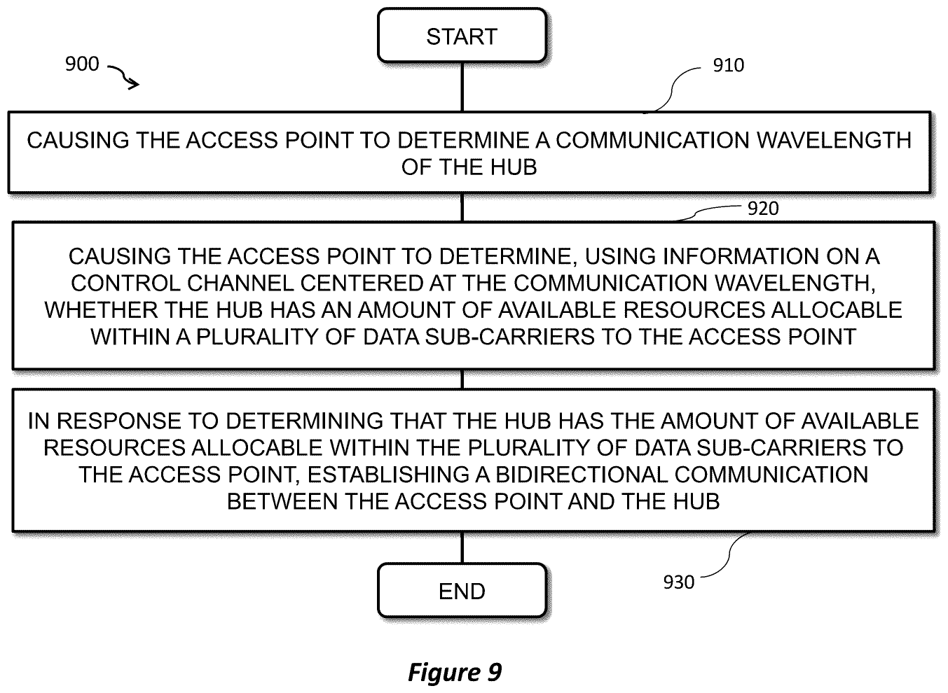

FIG. 9 is a flow diagram of a method 900 for providing communication between an access point and a HUB of a point-to-multipoint optical network. In one or more aspects, the method 900 or one or more steps thereof may be performed by a processor or a computer system, such as the computing unit 100. The method 900 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 900 start with causing, at operation 910, the access point to determine a communication wavelength of the HUB. In some implementations, causing the access point to determine a communication wavelength of the HUB includes tuning a central frequency of a local oscillator laser of the access point to a pre-determined wavelength and, in response to the communication wavelength of the HUB matching the pre-determined wavelength, locking a frequency and time of a sampling of the access point to the HUB.

In some embodiments, the method 900 may include a step of scanning by the access point pre-determined wavelengths for locking to the HUB.

In some implementations, causing the access point to determine whether the HUB has a pre-determined amount of resource to allocate to the access point includes receiving, by the HUB from the access point, the request comprising information about the pre-determined amount of resource for a potential establishment of a bidirectional communication between the access point and the HUB and transmitting, by the HUB to the access point, information about a presence or an absence of the pre-determined amount of resource.

The method 900 continues with causing, at operation 920, the access point to determine, using information on a control channel centered at the communication wavelength, whether the HUB has an amount of available resources allocable within a plurality of data sub-carriers to the access point. For example, the amount of available resources may be physical resources including bandwidth and data sub-carriers of the HUB.

In some implementations, the amount of available resources is determined based on characteristics of the access point.

For example, the HUB may transmit data to the access point over a downlink having a single polarization channel. and/or a dual polarization channel.

In the same or other implementations, causing the access point to determine, using the communication wavelength whether the HUB has available resource to allocate to the access point comprises causing the access point to receive, from the HUB, a training sequence, pilots and control symbols, perform clock and frequency synchronization with the HUB, extract System Initialization Control Channel (SICCH) MAC information from the control symbols, generate a list of available resources on the HUB, monitor a Broadcast Field in SICCH Frame to determine whether an uplink communication line is available from the access point to the HUB, upon determining that the uplink communication line is available, send a connection request to the HUB, the connection request comprising information about the amount of required resources and, in response to the amount of required resources being available at the HUB, receive a confirmation message therefrom.

The access point may send the connection request a plurality of successive times. Alternatively or optionally, the access point may wait a pre-determined amount of time after sending the connection request, and, in response to no confirmation message being received once the pre-determined amount of time has elapsed, sending a second connection request to the HUB, the second connection request comprising information about the amount of available resources.

The method 900 continues with establishing, at operation 930, in response to determining that the HUB has the amount of available resources allocable within the plurality of data sub-carriers to the access point, a bidirectional communication between the access point and the HUB.

In some implementations, the method 900 further includes, in response to the communication wavelength of the HUB being different than the pre-determined wavelength, iteratively adjusting the center frequency by a pre-determined amount.

In the same or other implementations, the method 900 further includes, subsequent to causing the access point to determine a communication wavelength of the HUB, transmitting, by the HUB to the access point, a sequence comprises an indicator indicative whether the HUB has resources to offer to the access point.

In some implementations, the method 900 further includes, in response to a bandwidth of the access point being equal or wider than a wavelength spectrum of the data sub-carries of the HUB, assigning one or more of the data sub-carriers to the access point and transmitting data between the HUB and the access point on the assigned data sub-carriers. In these implementations, the method 900 may further includes transmitting, by the HUB to the access point, a monitoring request indicative of parameters of the access point to be monitored, causing the access point to transmit a state of the parameters to the HUB a pre-determined number of times and updating, by the HUB, information indicative of a state of the access point based on the received state of the parameters. For example, the access point may transmit the state of the parameters using a Feedback Control Channel (FBCH).

It is contemplated that the FBCH may be available for use in both wide bandwidth cases narrow bandwidth case. In some examples, such as in FIGS. 5, 15 and 16, there is shown how similar inserted control channel is are used to include the MCCH in DL and FBCH in uplink the wide bandwidth case of the access point. In other examples, in FIGS. 6 and 18, there is shown how management can be optionally included in the data channel in the narrow bandwidth case of the access point. In further examples, such as in FIGS. 7 and 8, there is shown other alternatives in case of narrow bandwidth of the access point with dedicated or shared control tones.

In some implementations, the method 900 further includes, in response to a bandwidth of the access point being narrower than a wavelength spectrum of the data sub-carries of the HUB, causing the access point to tune a central frequency of a local oscillator laser thereof to match a given data sub-carriers of the hub and defining a control channel independent from a data channel configured for carrying data between the hub and the access point.

In the same or other implementations, the method 900 further includes transmitting, by the hub to the access point, a monitoring request indicative of parameters of the access point to be monitored, causing the access point to transmit a state of the parameters to the hub a pre-determined number of times and updating, by the hub, information indicative of a state of the access point based on the received state of the parameters.

While the above-described implementations have been described and shown with reference to particular operations performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

Therefore, it can be said that the present technology allows cost and operation reduction by automatic authentication of newly added access points, simplifies the network management and maintenance, may improve performance for the optical link and may reduce the link budget. It can help reduce the processing DSP at the node transceivers.

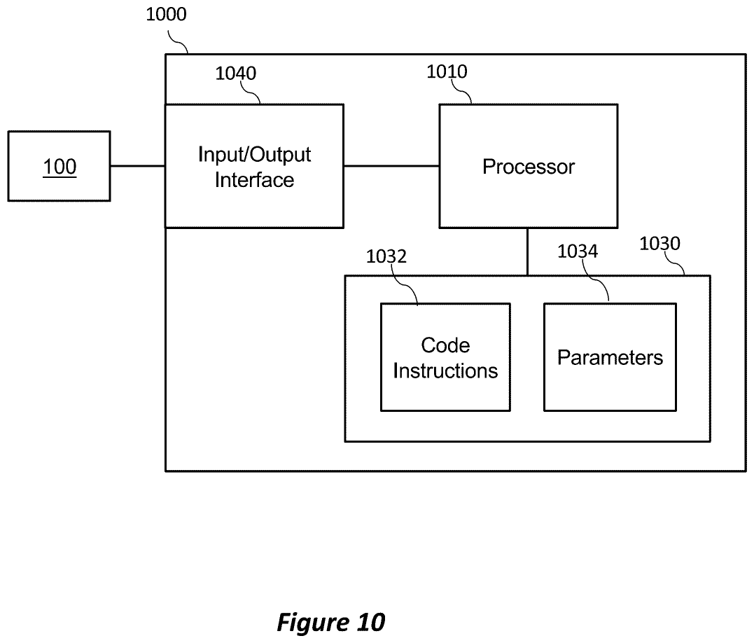

FIG. 10 is a schematic block diagram of a system 1000 according to some implementations of the present technology. The HUB and/or the AP 20 may be implemented as the system 1000 in some implementations. The system 1000 includes a processor or a plurality of cooperating processors (represented as a processor 1010 for simplicity), a memory device or a plurality of memory devices (represented as a memory device 1030 for simplicity), and an input/output interface 420 allowing the system 1000 to communicate with other components of the PTMP network 100. The processor 1010 is operatively connected to the memory device 1030 and to the input/output interface 1020. The memory device 1030 includes a storage for storing parameters 1034. The memory device 1030 may comprise a non-transitory computer-readable medium for storing code instructions 1032 that are executable by the processor 1010 to allow the system 1000 to perform the various tasks allocated to the system 1000 in the method of FIG. 9.

The system 1000 executes the code instructions 1032 stored in the memory device 1030 to implement the various above-described functions that may be present in a particular implementation. FIG. 10 as illustrated represents a non-limiting embodiment in which the system 1000 orchestrates operations of the HUB and/or the AP 20. This particular implementation is not meant to limit the present disclosure and is provided for illustration purposes.

What is claimed:

1. A method for providing communication between an access point and a HUB of a point-to-multipoint optical network, the method comprising:
causing the access point to determine a communication wavelength of the HUB;
causing the access point to determine, using information on a control channel centered at the communication wavelength, whether the HUB has an amount of available resources allocable within a plurality of data sub-carriers to the access point; and
in response to determining that the HUB has the amount of available resources allocable within the plurality of data sub-carriers to the access point, establishing a bidirectional communication between the access point and the HUB.

2. The method of claim 1, wherein the amount of available resources is determined based on characteristics of the access point.

3. The method of claim 1, wherein the causing the access point to determine the communication wavelength of the HUB comprises:
tuning a central frequency of a local oscillator laser of the access point to a pre-determined wavelength; and
in response to the communication wavelength of the HUB matching the pre-determined wavelength, locking a frequency and a time of sampling of the access point to the HUB.

4. The method of claim 3, the causing the access point to determine the communication wavelength of the HUB comprises:
scanning by the access point pre-determined wavelengths for locking to the HUB.

5. The method of claim 1, wherein the method further comprises, subsequent to the causing the access point to determine the communication wavelength of the HUB:
transmitting, by the HUB to the access point, a sequence comprising an indicator indicative of whether the HUB has resources to offer to the access point.

6. The method of claim 1, wherein the amount of available resource are physical resources comprising bandwidth and data sub-carriers of the HUB.

7. The method of claim 1, wherein the causing the access point to determining that the HUB has the amount of available resources allocable within the plurality of data sub-carriers to the access point comprises:
receiving, by the HUB from the access point, a request comprising information indicative of the amount of available resources for a potential establishment of a bidirectional communication between the access point and the HUB; and
transmitting, by the HUB to the access point, information about a presence or an absence of the amount of available resources.

8. The method of claim 1, wherein the causing the access point to determining that the HUB has the amount of available resources allocable within the plurality of data sub-carriers to the access point comprises:
receiving, from the HUB, a training sequence, pilots and control symbols;
performing clock and frequency synchronization with the HUB;
extracting System Initialization Control Channel (SICCH) MAC information from the control symbols;
generating a list of available resources on the HUB;
monitoring a Broadcast Field in SICCH Frame to determine whether an uplink communication line is available from the access point to the HUB;
upon determining that the uplink communication line is available, sending a connection request to the HUB, the connection request comprising information indicative of an amount of required resources; and
in response to the amount of required resources being available at the HUB, receiving a confirmation message therefrom.

9. The method of claim 8, wherein the method further comprises re-sending the connection request a plurality of successive times.

10. The method of claim 8, wherein the method further comprises waiting a pre-determined amount of time after sending the connection request, and, in response to no confirmation message being received once the pre-determined amount of time has elapsed, sending a second connection request to the hub, the second connection request comprising information about a pre-determined amount of second resources.

11. The method of claim 1, wherein the method further comprises:
in response to a bandwidth of the access point being equal or wider than a wavelength spectrum including the data sub-carriers of the HUB:
assigning one or more of the data sub-carriers to the access point; and
transmitting data between the HUB and the access point on the assigned data sub-carriers.

12. The method of claim 11, further comprising:
transmitting, by the HUB to the access point, a monitoring request indicative of parameters of the access point to be monitored;
causing the access point to transmit a state of the parameters to the HUB a pre-determined number of times;
updating, by the HUB, information indicative of a state of the access point based on the received state of the parameters.

13. The method of claim 12, wherein the transmitting the state of the parameters is performed using a Feedback Control Channel (FBCH).

14. The method of claim 1, wherein the method further comprises:
in response to a bandwidth of the access point being narrower than a wavelength spectrum of the data sub-carries of the HUB:
causing the access point to tune a central frequency of a local oscillator laser to match a given data sub-carriers of the HUB; and
defining the control channel independent from a data channel configured for carrying data between the HUB and the access point.

15. The method of claim 14, wherein the method further comprises:
transmitting, by the HUB to the access point, a monitoring request indicative of parameters of the access point to be monitored;
causing the access point to transmit a state of the parameters to the HUB a pre-determined number of times;
updating, by the HUB, information indicative of a state of the access point based on the received state of the parameters.

16. A system for providing communication between an access point and a HUB of a point-to-multipoint optical network, the system being configured to:
cause the access point to determine a communication wavelength of the HUB;
cause the access point to determine, using information on a control channel centered at the communication wavelength, whether the HUB has an amount of available resources allocable within a plurality of data sub-carriers to the access point; and
in response to determining that the HUB has the amount of available resources allocable within the plurality of data sub-carriers to the access point, establish a bidirectional communication between the access point and the HUB.

17. The system of claim 16, wherein the amount of available resources is determined based on characteristics of the access point.

18. The system of claim 16, wherein to cause the access point to determine the communication wavelength of the HUB comprises the system configured to:
tune a central frequency of a local oscillator laser of the access point to a pre-determined wavelength; and
in response to the communication wavelength of the HUB matching the pre-determined wavelength, lock a frequency and a time of sampling of the access point to the HUB.

19. The system of claim 18, wherein the causing the access point to determine the communication wavelength of the HUB comprises:
scanning by the access point pre-determined wavelengths for locking to the HUB.

20. The system of claim 16, wherein the system is configured to, subsequent to the causing the access point to determine the communication wavelength of the HUB:
transmit, by the HUB to the access point, a sequence comprising an indicator indicative of whether the HUB has resources to offer to the access point.
